(19) United States
(12) Patent Application Publication
(10) Pub. No.: US 2005/0106410 A1
(43) Pub. Date: May 19, 2005

(54) Aluminium alloy to be used as fin material

(76) Inventors: Xiao-Jun Jiang, Haugesund (NO); Morten Syslak, Haugesund (NO); Jon Dag Evensen, Lier (NO)

Correspondence Address: HARTMAN & HARTMAN, P.C., 552 EAST 700 NORTH, VALPARAISO, IN, 46383, US

(21) Appl. No.: 10/499,557

(22) PCT Filed: Dec. 16, 2002
(86) PCT No.: PCT/EP02/14323

(30) Foreign Application Priority Data
Dec. 21, 2001 (NO) 20016355

(51) Int. Cl. B32B 15/10

(52) U.S. Cl. 428/654

(57) ABSTRACT

A strong durable aluminum alloy fin material with enhanced corrosion resistance for brazed heat exchangers. The fin material includes a core material and a clad material on the core material. The core material consists of, by weight, 0.10-1.50% Si, 0.10-0.60% Fe, 0.00-1.00% Cu, 0.70-1.80% Mn, 0.00-0.40% Mg, 0.10-3.00% Zn, 0.00-0.30% Ti, 0.00-0.30% Zr, and the balance being Al and impurities. The clad material consists of, by weight, 4.00-14.00% Si, 0.10-0.80% Fe, 0.00-0.50% Cu, 0.00-0.50% Mn, 0.00-0.50% Mg, 0.03-3.00% Zn, 0.00-0.30% Ti, and the balance being Al and impurities.

Brazed aluminium components, produced by either vacuum brazing or controlled atmosphere brazing, have become the common choice for all major engine cooling and climate control systems such as condensers, evaporators, radiators and oil coolers. This invention relates to brazed aluminium beat exchangers, such as radiators, condensers, evaporators and heater cores, and, more particularly, to an aluminium fin alloy with excellent corrosion resistance and mechanical properties.

Heat exchanger units for use in automobiles were, until the 1970's, manufactured from copper and brass. The use of aluminium for automotive beat exchangers has increased dramatically in the last 20 years. Good corrosion resistance, formability and high thermal conductivity make aluminium an ideal material for the construction of these heat exchangers.

A typical brazed heat exchanger (radiator or condenser) comprises fins, tubes, sideplates and headerplates. Fins, tubes, sideplates and headers should be of different alloys to meet the requirements for the individual parts as well as for the complete heat exchanger. Over the last few years the requirements for aluminium fin stock have become more demanding. The major demand used to be on thermal conductivity, which is excellent for all aluminium alloys. However, nowadays, high strength fin materials, combined with corrosion properties that are tuned to the tube material, are required to enable down-gauging for weight saving, or the use of an increased amount of fins for increased cooling efficiency.

Controlled atmosphere brazing (CAB) relies on a flux to react with and remove the aluminium oxide. Fluoride-based fluxes, e.g. a mixture of potassium tetrafluoroalurminate and hexafluorotripotassium aluminate, are advantageous since they leave no corrosive residues. Aluminium brazing involves joining of components with a brazing alloy, that is an aluminium alloy (Al—Si) whose melting point is appreciably lower than that of the components. This brazing alloy is usually placed adjacent to or in between the components to be joined and assembly is then heated to a temperature where the brazing alloy melts but not the components. Upon cooling, the brazing alloy forms a metallurgical bond between the joining surfaces of the components. In automotive beat exchanger applications, this filler metal is supplied via a thin sheet or clad on a core alloy. The core provides structural integrity while the low melting point Al—Si cladding alloy melts and flows during the brazing process, to provide upon cooling a metallic bond between the components.

The fins are typically joined to the tubes or core plates by use of the clad layer on the tubes or plates. If required by the customers' process or design, and depending on the material used for the tubes, e.g. extruded tubes, fin material can also be clad on one or both sides to enhance the brazeability.

Unclad aluminium fin is manufactured by rolling alloy ingot down to a final gauge required by customers with different thermal treatments in between the rolling operation. Clad fin is manufactured by roll-bonding techniques to clad the core alloy ingot on one or both sides with the low melting point Al—Si alloy. Typically AA 1050, AA 1100, AA 3003, AA 3103 and AA 5005 are used in applications where high formability is required and severe corrosion is not expected. Not so long ago, these alloys, either with or without additional Zn, were the standard choice for fin material. AA 5005 has a relatively high Mg content and is therefore exclusively used in vacuum brazing. For the clad, typically AA 4343 or AA 4045 is used.

In service the heat exchanger component may be subjected to conditions that include: mechanical loading, vibration and salt water environments during winter driving conditions. The durability of a brazed aluminum heat exchanger in a corrosive environment is dependent on the inherent corrosion performance of each component (Header, fin, tube, etc.) and their relative electrochemical behaviour. It is common practice to tailor the fin/fin-cladding and header/header-cladding in such a way that these components and the fillers become sacrificial to the tube.

The alloy development is driven by customers' demands for down gauging, cost reductions, enhanced unit performance and longer service lives. As part of the overall target in the automotive industry to decrease weight and production costs, the heat exchanger market has to develop more effective designs on an ongoing basis. In turn this places demands on the material supplier to develop higher strength alloys, which enable down-gauging for lighter-weight structures, or the use of high pressure cycles, and/or an increased amount of fins for increased cooling efficiency. This increased performance must be achieved cost effectively and with brazing and corrosion performance equivalent to, or superior to, the existing material. With conventional alloys, it has been extremely difficult to achieve downgauging and downsizing. In addition, the desire for closed loop recycling of process scrap during manufacture and units at the end of the vehicle life is now a consideration.

Therefore, the target for fin development is to obtain fins which give cathodic protection both to tubes and to the fillets without showing excessive fin corrosion. The fins should resist sagging during brazing and have high post-braze strength. This can be controlled by the balance between Mn, Fe and Si.

The main object of this invention is to provide an improved recyclable and strong long life corrosion resistant aluminium alloy for manufacturing unclad fin for welded tube and mechanically assembled heat exchangers.

Another object of this invention is to provide an improved recyclable and strong long life corrosion resistant aluminium alloy sheet for manufacturing clad fin for extruded tube for both brazed and mechanically assembled heat exchangers. The alloy sheet consists of a core and a brazing metal clad on one side of the core.

It is yet another object of this invention to provide an improved recyclable and strong long life corrosion resistant aluminium alloy sheet for manufacturing clad fin for extruded tube for both brazed and mechanically assembled heat exchangers. The alloy sheet consists of a core and a brazing metal clad on both sides of the core.

It is still another object of this invention to produce heat exchangers with adequate corrosion performance in SWAAT (Sea Water Acetic Acid Test, ASTI G85) with alloy of this invention by optimising the material combination of fin, tube, header and sideplates. These and other objects of the invention are obtained by the products as described below. The invention is further described and characterized by the accompanying patent claims.

The invention thus concerns a method of increasing the corrosion durability and mechanical properties of a fin alloy, and furthermore, a heat exchanger, wherein the composition of core and clad alloys and the combination of fin, tube, header and sideplates have been optimised.

The preferred brazing alloy consists essentially of 14 weight % Si, maximum 0.8 weight % Fe, maximum 0.5 weight % Cu, maximum 0.5 weight % Mg, maximum 0.5 weight % MA, 0.03-3 weight % Zn, maximum 0.3 weight % Ti. The maximum content of other elements is 0.05 weight % each and a total of 0.15 weight % other elements, and the balance aluminium.

The invention also includes an aluminium core alloy for fin with a relatively high melting point, unclad or clad to at least one side of said core of an aluminium alloy with relatively low melting point of the above given compositions, suitable for controlled atmosphere brazing. The aluminium alloy core has the composition: 0.10-1.50% by weight Si, 0.10-0,60% by weight Fe, 0,00-1,00% by weight Cu, 0,70-1,80% by weight Mn, 0,00-0,40% by weight Mg, 0,10-3,00% by weight Zn, 0,00-0,30% by weight Ti, 0.00-0.30% by weight Zr.

The invention also relates to an aluminium alloy fin material having the above mentioned composition, in which at least one side of the fin material has been clad with an alloy consisting of 4,00-14,00% by weight Si, 0.10-0,80% by weight Fe, 0,00-0,50% by weight Cu, 0,00-0,50% by weight Mn, 0,00-0,50% by weight Mg, 0.03-3,00% by weight Zn, 0,00-0.30% by weight Ti.

The general role of different elements in 3xxx and 4xxx type alloys is described as follows.

The amount of Si affects the melting point of the brazing alloy. With respect to the claimed aluminium core, Si together with Fe is present at a level which is commonly found in recycled materials. Si is also an element to be used in this type of alloys to increase the strength. It is most effective as a precipitation hardener when combined with Mg in Mg₂Si. With the maximum Mg at 0.2 weight %, only about 0.12 weight Si can be effective in this way. Si can also be combined with Fe and Mn in α-Al₁₅(Fe,Mn)₃Si₂. With Fe⁺ Mn<1.75 weight %, the maximum Si that can be incorporated in α-Al₁₅(Fe,Mn)₃Si₂ is about 0.6 weight %. All excess Si then is available either for solid solution strengthening or for precipitation hardening as free Si. A disadvantage in the use of Si is its reduction of the Melting temperature. To ensure that the fin alloy does not melt during the brazing processes, the Si level is limited to 1.5 weight %.

Recycled metal contains relatively high levels of Fe (up to 0.8 weight %). In order to lead to both energy and cost saving, ideally both core and clad materials should be produced from as much recycled metal as possible. There is a compromise between amount of scrap entering industrial production and final corrosion properties of the product. Pitting corrosion may take place in the vicinity of Al₃Fe particles which are highly cathodic compared to the matrix. However, when Mn is present, (Fe,Mn)Al₆ particles will form instead and these particles have approximately the same electrochemical potential as Al. The size and distribution of Fe-bearing primary particles may play a major role in whether the mode of corrosion attack will be pitting or general.

Zn renders the alloy less noble. The corrosion behaviour of an alloy is sometimes deliberately altered by adding Zn, thus resulting in a sacrificial anode effect, Therefore, Zn can be actively used to alter the corrosion potential of the various components (cladding, fin, header) in a heat exchanger unit. By the concept of design against corrosion it is possible to direct corrosion attack preferentially to the least harmful regions of the heat exchanger e.g. fins and/or fillet area, thus protecting the tube from perforation. This means that when the heat exchanger is in service, the fin will corrode preferentially to the tubes or plates. Corroded fins reduce the heat exchanging capabilities of the unit but at least the unit can continue operating. Moreover, it is thought that relatively small amounts of Zn will make the oxide weaker resulting in lateral corrosion attacks rather than pitting. Zn content in the claimed alloy has been fine tuned to ensure that the fin is sacrificial to the tube material, Cu contributes to solid solution strengthening of the material. Similar to Zn, Cu also gives a strong electrochemical effect on the material. However, Cu shifts the corrosion potential to a more noble value when it is retains in solid solution after brazing. Moreover, Cu in Al alloys is perceived to resent a corrosion problem often associated with the formation of CuAl₂ particles and solid solution strengthening does not usually aid high temperature stability. From a design against corrosion point of view, the content of Zn and Cu in a fin alloy has to be balanced to make fin more anodic than tube.

Mn is the main alloying element in 3xxx alloys. Mn is used to increase the strength by solid solution and dispersoid hardening, A high level is therefore desirable. The disadvantage of relatively high levels of Mn is the potential formation of large primary intermetallics of the type (FeMn)Al₆ which do not redissolve easily.

Mg is commonly used to increase strength in Al alloys, either through solid solution hardening or by precipitation hardening in combination with other elements, especially Si. In the core material Mg primarily contributes to solid solution strengthening of the material. However, when normal Nokolock™ flux is used for brazing, the content has to be restricted to maximum about 0.4 weight % in the core and about 0.1 weight % in the brazing clad, respectively, since higher levels will reduce the brazeability of the sheet. During brazing Mg diffuses towards the surface and reacts with the Nokolock™ flux and thereby reduces the brazeability by poisoning the standard flux.

Tailored additions of Ti and Zr are known to increase strength. Ti can also be added to alloy to increase the corrosion resistance. It has been reported that Ti changes the corrosion mechanism from localised pitting to a lamellar corrosion mode in Al—Mn alloys, which increases the time to perforation. However, potential large intermetallics of the type (Zr,Ti)Al₃ limit both Ti and Zr additions. So, they should be used with careful consideration of their interactions.

### EXAMPLE 1

Preferred unclad aluminium fin alloy for welded lube of Hydro “Long Life” alloy (Patent Application number PCT/RP/00/01518) has the composition: 1.4 to 1.7 weight % Mn, 0.5 to 1.0 weight % Si, maximum 0.45 weight % Fe, 1.9 to 2.0 weight % Zn, maximum 0.10 weight % Cu, maximum 0.05 weight % Mg, 0.12 to 0.15 weight % Ti, 0.1 to 0.18 weight % Zr, and where the maximum content of other elements is 0.05 weight % each, and a total of 0.15 weight % other elements, and the balance aluminium. Typical pre- and post-braze mechanical properties of this alloy is given in Table 1.

TABLE 1
Typical pre- and post-braze mechanical properties of the
claimed fin alloy

| | Rp0.2 (MPa) | Rm (MPa) | A50 (%) |
|---|---|---|---|
| Pre-braze | 190 | 204 | 23 |
| Post-braze | 59 | 136 | 111 |

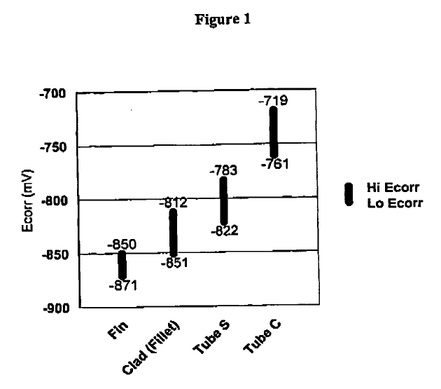

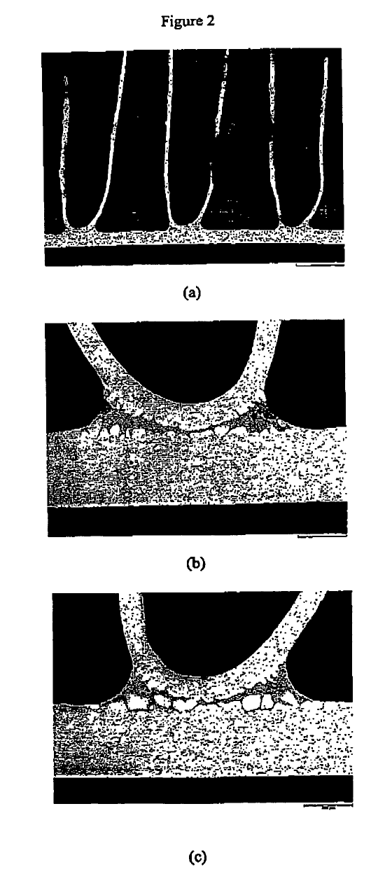

In order to protect tubes in a heat exchange, fin used in the heat exchanger must be more anodic than fin to tube joints and tubes. As it has been mentioned, Zn renders the alloy less noble. In the claimed fin alloy, Zn is added to tune the corrosion potential (Ecorr) of the fin to match the welded tube of Hydro “Long Life” alloy (Patent Application number PCT/EP/00/001,518). The annexed FIG. 1 shows the predicted Ecorr of fin, joint fillet, tube surface and tube core in a heat exchanger brazed with the claimed fin and the welded tube of Hydro “Long Life” alloy, It can be seen that the whole system has a good galvanic situation. Corrosion test (SWAAT and neutral saltspray) on prototype radiators of this material combination showed that the radiators have excellent galvanic corrosion design; the fin and the tube alloys have excellent inherent corrosion resistance. After the corrosion test, some of the fin and fin to tube joints corroded slightly; while all the tubes and most of the fin to tube joints kept intact. Fins have provided galvanic protection to the tubes and fin to tube joints. FIG. 2 shows micrographs taken from a radiator with material combination of the claimed fin and the welded tube of Hydro “Long Life” alloy after 28 days SWAAT exposure. FIG. 2a shows that some of the fins have corroded slightly, FIG. 2b shows that some of the fin to tube joints have corroded slightly and FIG. 2c shows that most of the fin to tube joints have been kept in tact.

### EXAMPLE 2

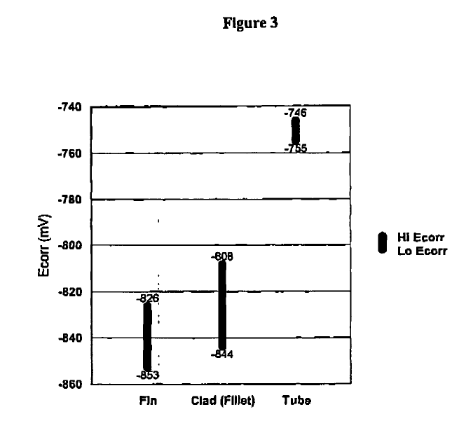

Clad fin for extruded tube of Hydro “Long Life” alloy consists of a core and a brazing metal. The said brazing metal clad on at lease one side of said core. Preferred brazing metal has the composition: maximum 0.1 weight % Mn, 6.8 to 8.2 weight % Si, 0.1 to 0.3 weight % Fe, typically 0.05 weight % Zn, 0.1 to 0.25 weight % Cu, maximum 0.05 weight % Mg, maximum 0.1 weight % Ti, and where the maximum content of other elements is 0.05 weight % each, and a total of 0.15 weight % other elements, and the balance aluminium. Preferred aluminium core alloy has the composition: 14 to 1.7 weight % Mn, 0.5 to 1.0 weight % Si, maximum 0.45 weight % Fe, 1.2 to 1.7 weight % Zn, maximum 0.05 weight % Cu, maximum 0.05 weight % Mg, 0.12 to 0.15 weight % Ti, 0.1 to 0.18 weight % Zr, and the maximum content of other elements is 0.05 weight % each, and a total of 0.15 weight % other elements, and the balance aluminium. Typical pre- and post-braze mechanical properties of this alloy is given in Table 2. Predicted corrosion potential (Ecorr) of fin, joint fillet and tube in a heat exchanger brazed with the claimed fin and the extruded tube of Hydro long life alloy is shown in FIG. 3.

TABLE 2
Typical pre- and post-braze mechanical properties of the claimed
clad fin alloy

| | Rp0.2 (MPa) | Rm (MPa) | A50 (%) |
|---|---|---|---|
| Pre-braze | 167 | 173 | 14 |
| Post-braze | 62 | 146 | 83 |

In general, Zn renders alloy less noble, with increasing Zn content Ecorr of the component decreases dramatically. As mentioned in Example 1, in a heat exchanger, fins should be more anodic than tubes and fin to tube joints in order to protect not only the tubes but also the joints. This is to keep efficient thermal transferring. In a heat exchanger with material combination of clad fin and extruded rube, all fin to tube joint fillets are formed from melted cladding during brazing. Therefore, Zn is added to the core but not the clad of the claimed fin alloy. The reason for this is to try to make fins more anodic than both the fillets and the tubes after brazing.

One may argue that in FIG. 3 there is an overlapping between the range of Ecorr for fin and the range of Ecorr for fillet. However, in all the figures presented, Hi Ecorr reflexes chemical composition of an alloy or a component in a heat exchanger which could give the possible highest corrosion potential and Lo Ecorr reflexes chemical composition of an alloy or a component in a heat exchanger which could give the possible lowest corrosion potential. According to the calculation, Ecorr of the fillet is moving along with the Ecorr of the fin towards the same direction, e.g. when reducing Zn content in the fin, Ecorr of fin moves up towards Hi Ecorr, meanwhile, Ecorr of the fillet is moving up towards Hi Ecorr too and vice versa. Therefore, the whole system may have a good galvanic situation.

### EXAMPLE 3

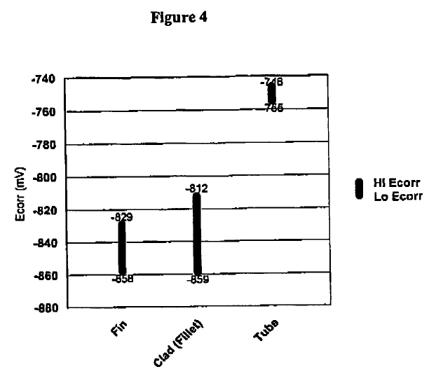

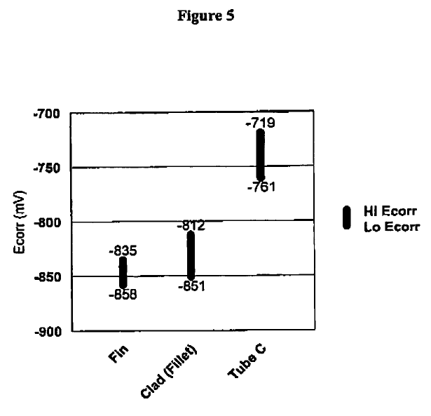

Aluminium alloy which can be used for both unclad fin for welded tube of Hydro “Long Life” alloy and core of clad fin for extruded tube of Hydro “Long Life” alloy. A brazing metal should be clad on at lease one side of said core when the alloy is used for clad fin. Preferred brazing metal has the composition: maximum 0.1 weight % Mn, 6.8 to 8.2 weight % Si, 0.1 to 0.3 weight % Fe, typically 0.05 weight % Zn, 0.1 to 0.25 weight % Cu, maximum 0.05 weight % Mg, maximum 0.1 weight % Ti, and where the maximum content of other elements is 0.05 weight % each, and a total of 0.15 weight % other elements, and the balance aluminium. Preferred aluminium alloy has the composition: 1.0 to 1.5 weight % Mn, 1.2 to 1.5 weight % Si, 0.35 to 0.5 weight % Fe, 1.8 to 2.0 weight % Zn, 0.1 to 0.15 weight % Cu, maximum 0.05 weight % Mg, maximum 0.01 weight % Ti, maximum 0.01 weight % Zr, and the maximum content of other elements is 0.05 weight % each, and a total of 0.15 weight % other elements, and the balance aluminium. Scrap analysis of various recycled heat exchanger gives the following chemical composition: 1.321 weight % Si, 0.373 weight % Fe, 0.115 weight % Cu, 1.102 weight % Mn, 0.018 weight % Mg, 0.495 weight % Zn, 0.010 weight % Ti and 0.005 weight % Zr, which is within the range of the claimed alloy. Therefore, the claimed alloy can be produced directly from recycled material. Predicted corrosion potentials (Ecorr) of fin, joint fillet and tube in a heat exchanger brazed with the claimed fin and the welded tube or extruded tube of Hydro “Long Life” alloys are shown in FIGS. 4 and 5. Although there is an overlapping between the range of Ecorr for fin and the range of Ecorr for fillet in the figures, for the reason that has been discussed above the whole system may have a good galvanic situation.

1-45. (canceled)

46. An aluminum alloy fin material for use in an aluminum heat exchanger, the fin material comprising a core material and a clad material on the core material, the core material consisting of:
0.10-1.50% by weight Si;
0.10-0.60% by weight Fe;
0.00-1.00% by weight Cu;
0.70-1.80% by weight Mn;
0.00-0.40% by weight Mg;
0.10-3.00% by weight Zn;
0.00-0.30% by weight Ti;
0.00-0.30% by weight Zr; and
the balance being Al and impurities; and
the clad material consisting of:
4.00-14.00% by weight Si;
0.10-0.80% by weight Fe;
0.00-0.50% by weight Cu;
0.00-0.50% by weight Mn;
0.00-0.50% by weight Mg;
0.03-3.00% by weight Zn;
0.00-0.30% by weight Ti; and
the balance being Al and impurities.

47. An aluminum alloy according to claim 46, wherein the Si content of the clad material is at least 5.50% by weight.

48. An aluminum alloy according to claim 46, wherein the Si content of the clad material is at least 6.80% by weight.

49. An aluminum alloy according to claim 46, wherein the Si content of the clad material is at most 12.00% by weight.

50. An aluminum alloy according to claim 46, wherein the Si content of the clad material is at most 8.20% by weight.

51. An aluminum alloy according to claim 46, wherein the Fe content of the clad material is at most 0.30% by weight.

52. An aluminum alloy according to claim 46, wherein the Cu content of the clad material is at least 0.10% by weight.

53. An aluminum alloy according to claim 46, wherein the Cu content of the clad material is at most 0.25% by weight.

54. An aluminum alloy according to claim 46, wherein the Mn content of the clad material is at most 0.10% by weight.

55. An aluminum alloy according to claim 46, wherein the Mg content of the clad material is at most 0.05% by weight.

56. An aluminum alloy according to claim 46, wherein the Zn content of the clad material is at most 0.10% by weight.

57. An aluminum alloy according to claim 46, wherein the Ti content of the clad material is at most 0.10% by weight.

58. An aluminum alloy according to claim 46, wherein the Mg content of the core material is at most 0.05% by weight.
